(19) United States
(12) Patent Application Publication
(10) Pub. No.: US 2023/0206166 A1
(43) Pub. Date: Jun. 29, 2023

(54) DELIVERY ASSEMBLY TO HELP FACILITATE DELIVERY OF ITEMS BY AUTONOMOUS VEHICLES

(71) Applicant: GM Cruise Holdings LLC, San Francisco, CA (US)

(72) Inventors: Timothy Jon Meador, Fairfield, CA (US); Alexis DeStasio, San Francisco, CA (US); Matthew Martin, Fairfax, CA (US); Andrew W. Clavijo, Hayward, CA (US)

(73) Assignee: GM Cruise Holdings LLC, San Francisco, CA (US)

(21) Appl. No.: 17/561,532

(22) Filed: Dec. 23, 2021

(51) Int. Cl. G06Q 10/08; H04N 7/18; G07C 9/00

(52) U.S. Cl. CPC G06Q 10/0833; H04N 7/183; G07C 9/00896; G07C 9/00309

(57) ABSTRACT

Particular embodiments described herein provide for a system and method for facilitating autonomous delivery using a delivery assembly transported by an autonomous vehicle, the system and method can include determining that one or more items have been placed inside a specific cubby of the delivery assembly, capturing an image of the one or more items inside the specific cubby, and communicating the captured image to a customer user. In some examples the captured image is a video of the one or more items inside the specific cubby and the captured image is communicated a user's mobile device associated with the customer user.

### TECHNICAL FIELD OF THE DISCLOSURE

The present disclosure relates generally to autonomous vehicles (AVs) and, more specifically, to a delivery assembly to help facilitate delivery of items by such vehicles.

### BACKGROUND

An AV is a vehicle that is capable of sensing and navigating its environment with little or no user input. An autonomous vehicle may sense its environment using sensing devices such as Radio Detection and Ranging (RADAR), Light Detection and Ranging (LIDAR), image sensors, cameras, and the like. An autonomous vehicle system may also use information from a global positioning system (GPS), navigation systems, vehicle-to-vehicle communication, vehicle-to-infrastructure technology, and/or drive-by-wire systems to navigate the vehicle. As used herein, the phrase “autonomous vehicle” includes both fully autonomous and semi-autonomous vehicles.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

Figure (FIG. 1 shows an autonomous delivery environment according to some embodiments of the present disclosure;

FIG. 2 is a block diagram illustrating an online system according to some embodiments of the present disclosure;

FIG. 3 is a block diagram illustrating an onboard controller of an AV according to some embodiments of the present disclosure;

FIG. 4 illustrates a delivery assembly according to some embodiments of the present disclosure;

FIG. 5 illustrates another delivery assembly according to some embodiments of the present disclosure;

FIG. 6 illustrates another delivery assembly according to some embodiments of the present disclosure;

FIG. 7 illustrates a portion of a delivery assembly according to some embodiments of the present disclosure;

FIG. 8 illustrates a user mobility device according to some embodiments of the present disclosure; and

FIG. 9 illustrates a portion of a delivery assembly according to some embodiments of the present disclosure.

The FIGURES of the drawings are not necessarily drawn to scale, as their dimensions can be varied considerably without departing from the scope of the present disclosure.

### DESCRIPTION OF EXAMPLE EMBODIMENTS OF THE DISCLOSURE

Overview

The demand for contactless delivery robots has been rising. However, many contactless delivery robots cannot meet the rising demand due to high cost and technical challenges. For example, many contactless delivery robots are designed for delivering a particular type of item and cannot be used to delivery different items. Also, these robots cause safety and privacy risks. Therefore, improved technology for autonomous delivery is needed.

An autonomous delivery system including a delivery assembly secured in an AV overcomes these problems. The system uses localization and navigation capabilities of the AV as well as safety and privacy features of the delivery assembly to provide a more advantageous autonomous delivery method. The AV can navigate to delivery destinations and control users' access to the delivery assembly by using its onboard sensors and onboard controller. For instance, the onboard controller detects whether the AV has arrived at the destination and opens a door of the AV after the AV has arrived to allow access to the delivery assembly. The delivery assembly can have a user interface (UI) module that authenticates the user, allows the user to access one or more cubbies in the delivery assembly, and can generally help facilitate the delivery of one or more items to the user. After the user had collected one or more items from the one or more cubbies in the delivery assembly, the AV can close the door and continue to a next destination.

The delivery assembly is secured (e.g., removably secured) in the AV and facilitates delivering items to users or picking up items from users by using the AV. In some embodiments, the delivery assembly includes the one or more cubbies and the UI module. The one or more cubbies contain the items within a secured space (e.g., during the AV's motion). Each of the one or more cubbies can have various configurations to fit different types of items. In addition, the one or more cubbies in the delivery assembly can include one or more safety features or privacy features to help secure and protect the items. The UI module provides information of the delivery to the user and allows the user to provide input for authenticating the user.

The autonomous delivery system leverages the autonomous features of the AV such as autonomous localization, navigation, and door control. Also, it can provide safe and private delivery service by using the delivery assembly. Further, the delivery assembly can be taken out of the AV so that the AV can still be used for other purposes (e.g., rideshare). By combining the AV and the delivery assembly, the high cost and technical challenges for autonomous delivery can be reduced or even avoided. Also, the safety and privacy of users are better protected.

Embodiments of the present disclosure provide a method for autonomous delivery. The method includes facilitating autonomous delivery using a delivery assembly transported by an autonomous vehicle by determining that one or more items have been placed inside a specific cubby of the delivery assembly, capturing an image of the one or more items inside the specific cubby and communicating the captured image to a customer user. The captured image can be a video of the one or more items inside the specific cubby and can be communicated a user's mobile device associated with the customer user. In some examples, the method can include determining a current location of the delivery assembly transported by the autonomous vehicle and communicating the current location of the delivery assembly to the customer user. Also, the captured image and the current location of the delivery assembly are communicated a user's mobile device associated with the customer user. In addition, the method can include determining that the delivery assembly transported by the autonomous vehicle has arrived at a delivery location for delivery of the one or more items to the customer user, determining that the customer user has access to the one or more items in the specific cubby, and unlocking and opening a door to the specific cubby to allow the user to access the one or more items. Further, the method can include determining that the user has removed the one or more items from the specific cubby and closing and locking the door to the specific cubby. In some examples, a user interface is configured to determine if the customer user has access to the one or more items by authenticating the user. After the user interface authenticates the customer user, a captured image of the one or more items is displayed on the user interface. Also, after the user interface authenticates the customer user a specific cubby for the user to access can be illuminated.

As will be appreciated by one skilled in the art, aspects of the present disclosure, in particular aspects of dispatch-based charging for electric vehicle fleets, described herein, may be embodied in various manners (e.g., as a method, a system, a computer program product, or a computer-readable storage medium). Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Functions described in this disclosure may be implemented as an algorithm executed by one or more hardware processing units (e.g., one or more microprocessors) of one or more computers. In various embodiments, different steps and portions of the steps of each of the methods described herein may be performed by different processing units. Furthermore, aspects of the present disclosure may take the form of a computer program product embodied in one or more computer-readable medium(s), preferably non-transitory, having computer-readable program code embodied (e.g., stored), thereon. In various embodiments, such a computer program may, for example, be downloaded (updated) to the existing devices and systems (e.g., to the existing perception system devices or their controllers, etc.) or be stored upon manufacturing of these devices and systems.

The following detailed description presents various descriptions of specific certain embodiments. However, the innovations described herein can be embodied in a multitude of different ways, for example, as defined and covered by the claims or select examples. In the following description, reference is made to the drawings where like reference numerals can indicate identical or functionally similar elements. It will be understood that elements illustrated in the drawings are not necessarily drawn to scale. Moreover, it will be understood that certain embodiments can include more elements than illustrated in a drawing or a subset of the elements illustrated in a drawing. Further, some embodiments can incorporate any suitable combination of features from two or more drawings. Other features and advantages of the disclosure will be apparent from the following description and the claims.

As described herein, one aspect of the present technology may be the gathering and use of data available from various sources to improve quality and experience. The present disclosure contemplates that in some instances, this gathered data may include personal information. The present disclosure contemplates that the entities involved with such personal information respect and value privacy policies and practices.

As described herein, one aspect of the present technology increase safety of users interacting with the present technology and to improve quality and experience of these users. The present disclosure contemplates that the entities involved providing safety features respect and value safety-related laws, policies, and practices.

The following disclosure describes various illustrative embodiments and examples for implementing the features and functionality of the present disclosure. While particular components, arrangements, or features are described below in connection with various example embodiments, these are merely examples used to simplify the present disclosure and are not intended to be limiting. It will of course be appreciated that in the development of any actual embodiment, numerous implementation-specific decisions must be made to achieve the developer's specific goals, including compliance with system, business, or legal constraints, which may vary from one implementation to another. Moreover, it will be appreciated that, while such a development effort might be complex and time-consuming; it would nevertheless be a routine undertaking for those of ordinary skill in the art having the benefit of this disclosure.

In the Specification, reference may be made to the spatial relationships between various components and to the spatial orientation of various aspects of components as depicted in the attached drawings. However, as will be recognized by those skilled in the art after a complete reading of the present disclosure, the devices, components, members, apparatuses, etc. described herein may be positioned in any desired orientation. Thus, the use of terms such as “above”, “below”, “upper”, “lower”, “top”, “bottom”, or other similar terms to describe a spatial relationship between various components or to describe the spatial orientation of aspects of such components, should be understood to describe a relative relationship between the components or a spatial orientation of aspects of such components, respectively, as the components described herein may be oriented in any desired direction. When used to describe a range of dimensions or other characteristics (e.g., time, pressure, temperature, length, width, etc.) of an element, operations, or conditions, the phrase “between X and Y” represents a range that includes X and Y. In addition, the terms “comprise,” “comprising,” “include,” “including,” “have,” “having” or any other variation thereof, are intended to cover a non-exclusive inclusion. For example, a method, process, device, or system that comprises a list of elements is not necessarily limited to only those elements but may include other elements not expressly listed or inherent to such method, process, device, or system.

In the following detailed description, reference is made to the accompanying drawings that form a part hereof wherein like numerals designate like parts throughout, and in which is shown, by way of illustration, embodiments that may be practiced. It is to be understood that other embodiments may be utilized and structural or logical changes may be made without departing from the scope of the present disclosure. Therefore, the following detailed description is not to be taken in a limiting sense. For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B, and C). Reference to “one embodiment” or “an embodiment” in the present disclosure means that a particular feature, structure, or characteristic described in connection with the embodiment is included in at least one embodiment. The appearances of the phrase “in one embodiment” or “in an embodiment” are not necessarily all referring to the same embodiment. The appearances of the phrase “for example,” “in an example,” or “in some examples” are not necessarily all referring to the same example. The term “about” includes a plus or minus fifteen percent (±15%) variation.

The systems, methods and devices of this disclosure each have several innovative aspects, no single one of which is solely responsible for all of the desirable attributes disclosed herein. Details of one or more implementations of the subject matter described in this Specification are set forth in the description below and the accompanying drawings.

It is to be understood that other embodiments may be utilized and structural changes may be made without departing from the scope of the present disclosure. Substantial flexibility is provided by an electronic device in that any suitable arrangements and configuration may be provided without departing from the teachings of the present disclosure.

As used herein, the term “when” may be used to indicate the temporal nature of an event. For example, the phrase “event ‘A’ occurs when event ‘B’ occurs” is to be interpreted to mean that event A may occur before, during, or after the occurrence of event B, but is nonetheless associated with the occurrence of event B. For example, event A occurs when event B occurs if event A occurs in response to the occurrence of event B or in response to a signal indicating that event B has occurred, is occurring, or will occur.

Example Autonomous Delivery System

FIG. 1 shows an autonomous delivery environment 100 according to some embodiments of the present disclosure. The autonomous delivery environment 100 can include AVs 102, a delivery assembly 104, an online system 106, a client device 108, and a third-party device 110. Each of the AVs 102, the delivery assembly 104, the online system 106, the client device 108, and/or the third-party device 110 can be in communication using network 112. In addition, each of the AVs 102, the delivery assembly 104, the online system 106, the client device 108, and/or the third-party device 110 can be in communication with one or more network elements 114, one or more servers 116, and cloud services 118 using the network 112. In other embodiments, the autonomous delivery environment 100 may include fewer, more, or different components. For instance, the autonomous delivery environment 100 may include a different number of AVs 102 with some AVs 102 including a delivery assembly 104 and some AVs 102 not including a delivery assembly 104 (not shown). A single AV is referred to herein as AV 102, and multiple AVs are referred to collectively as AVs 102. For purpose of simplicity and illustration, FIG. 1 shows one client device 108 and one third-party device 110. In other embodiments, the autonomous delivery environment 100 includes multiple third-party devices or multiple client devices.

In some embodiments, the autonomous delivery environment 100 includes one or more communication networks (e.g., network 112) that supports communications between some or all of the components in the autonomous delivery environment 100. The network 112 may comprise any combination of local area and/or wide area networks, using both wired and/or wireless communication systems. In one embodiment, the network uses standard communications technologies and/or protocols. For example, the network 112 can include communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 112 may be represented using any suitable format, such as hypertext markup language (HTML) or extensible markup language (XML). In some embodiments, all or some of the communication links of the network 112 may be encrypted using any suitable technique or techniques.

The AV 102 is a vehicle that is capable of sensing and navigating its environment with little or no user input. The AV 102 may be a semi-autonomous or fully autonomous vehicle, e.g., a boat, an unmanned aerial vehicle, a driverless car, etc. Additionally, or alternatively, the AV 102 may be a vehicle that switches between a semi-autonomous state and a fully autonomous state and thus, the AV may have attributes of both a semi-autonomous vehicle and a fully autonomous vehicle depending on the state of the vehicle. The AV 102 may include a throttle interface that controls an engine throttle, motor speed (e.g., rotational speed of electric motor), or any other movement-enabling mechanism; a brake interface that controls brakes of the AV (or any other movement-retarding mechanism); and a steering interface that controls steering of the AV (e.g., by changing the angle of wheels of the AV). The AV 102 may additionally or alternatively include interfaces for control of any other vehicle functions; e.g., windshield wipers, headlights, turn indicators, air conditioning, etc.

In some embodiments, an AV 102 includes an onboard sensor suite. The onboard sensor suite detects the surrounding environment of the AV 102 and generates sensor data describing the surround environment. The onboard sensor suite may include various types of sensors. In some embodiments, the onboard sensor suite includes a computer vision (“CV”) system, localization sensors, and driving sensors. For example, the onboard sensor suite may include photodetectors, cameras, RADAR, Sound Navigation And Ranging (SONAR), LIDAR, GPS, wheel speed sensors, inertial measurement units (IMUS), accelerometers, microphones, strain gauges, pressure monitors, barometers, thermometers, altimeters, ambient light sensors, etc. The sensors may be located in various positions in and around the AV 102.

In some embodiments, the onboard sensor suite may include one or more sensors for a delivery assembly 104 that is secured in the AV 102. The delivery assembly 104 can help facilitate the delivery of items (e.g., prepared foods, groceries, packages, etc.) by the AV 102. The delivery assembly 104 defines a space where the items can be stored in the AV 102. The space may be a controlled environment. For example, access to space inside the delivery assembly 104 where items are stored may requirement authentication of the identify of a user. As another example, a physical condition (e.g., temperature, lightening, etc.) of the space is maintained at a desired level. The delivery assembly 104 may include features that facilitate users (e.g., customers or personnel of a retail entity) to load or unload items from the AV 102. The delivery assembly 104 may support a UI that provides the users information regarding the loading or unloading process. The UI may also allow the users to interact with the delivery assembly 104 or the AV 102 during the loading or unloading process. The delivery assembly 104 may include safety features to protect the safety of the users during the loading or unloading process. The delivery assembly 104 may also include privacy features to protect the privacy of the user.

The AV 102 also includes an onboard controller. The onboard controller controls operations and functionality of the AV 102. In some embodiments where the AV 102 includes the delivery assembly 104, the onboard controller may control some operations and functionality of the delivery assembly 104. In other embodiments where the AV 102 includes the delivery assembly 104, the operations and functionality of the delivery assembly 104 is separate from the onboard controller. In some embodiments, the onboard controller is a general-purpose computer, but may additionally or alternatively be any suitable computing device. The onboard controller is adapted for I/O communication with other components of the AV 102 (e.g., the onboard sensor suite, an UI module of the delivery assembly, etc.) and external systems (e.g., the online system 106). The onboard controller may be connected to the Internet via a wireless connection (e.g., via a cellular data connection). Additionally or alternatively, the onboard controller may be coupled to any number of wireless or wired communication systems.

The onboard controller processes sensor data generated by the onboard sensor suite and/or other data (e.g., data received from the online system 106) to determine the state of the AV 102. Based upon the vehicle state and programmed instructions, the onboard controller modifies or controls behavior of the AV 102. In some embodiments, the onboard controller implements an autonomous driving system (ADS) for controlling the AV 102 and processing sensor data from the onboard sensor suite and/or other sensors in order to determine the state of the AV 102. Based upon the vehicle state and programmed instructions, the onboard controller modifies or controls driving behavior of the AV 102.

The AV 102 may also include a rechargeable battery that powers the AV 102. The battery may be a lithium-ion battery, a lithium polymer battery, a lead-acid battery, a nickel-metal hydride battery, a sodium nickel chloride (“zebra”) battery, a lithium-titanate battery, or another type of rechargeable battery. In some embodiments, the AV 102 is a hybrid electric vehicle that also includes an internal combustion engine for powering the AV 102 (e.g., when the battery has low charge). In some embodiments, the AV 102 includes multiple batteries (e.g., a first battery used to power vehicle propulsion, and a second battery used to power AV hardware (e.g., the onboard sensor suite and the onboard controller 117)). The AV 102 may further include components for charging the battery (e.g., a charge port configured to make an electrical connection between the battery and a charging station).

The online system 106 manages delivery services using the AVs 102. A delivery service is a delivery of one or more items from one location to another location. In some embodiments, a delivery service is a service for picking up an item from a location of a business (e.g., a grocery store, a distribution center, a warehouse, etc.) and delivering the item to a location of a customer of the business. In other embodiments, a delivery service is a service for picking up an item from a customer of the business and delivering the item to a location of the business (e.g., for purpose of returning the item).

The online system 106 may select an AV 102 from a fleet of AVs 102 to perform a particular delivery service and instruct the selected AV 102 to autonomously drive to a particular location. The online system 106 sends a delivery request to the AV 102. The delivery request includes information associate with the delivery service (e.g., information of a user requesting the delivery such as location, identifying information, etc.), information of an item to be delivered (e.g., size, weight, or other attributes), etc. In some embodiments, the online system 106 may instruct one single AV 102 to perform multiple delivery services. For instance, the online system 106 instructs the AV 102 to pick up items from one location and delivery the items to multiple locations, or vice versa. The online system 106 also manages maintenance tasks, such as charging and servicing of the AVs 102. As shown in FIG. 1, each of the AVs 102 communicates with the online system 106. The AVs 102 and online system 106 may connect over a public network, such as the Internet.

In some embodiments, the online system 106 may also provide the AV 102 (and particularly, onboard controller 145) with system backend functions. The online system 106 may include one or more switches, servers, databases, live advisors, or an automated voice response system (VRS). The online system 106 may include any or all of the aforementioned components, which may be coupled to one another via a wired or wireless local area network (LAN). The online system 106 may receive and transmit data via one or more appropriate devices and network from and to the AV 102, such as by wireless systems, such as 882.11x, GPRS, and the like. A database at the online system 106 can store account information such as subscriber authentication information, vehicle identifiers, profile records, behavioral patterns, and other pertinent subscriber information. The online system 106 may also include a database of roads, routes, locations, etc. permitted for use by AV 102. The online system 106 may communicate with the AV 102 to provide route guidance in response to a request received from the vehicle.

For example, based upon information stored in a mapping system of the online system 106, the online system 106 may determine the conditions of various roads or portions thereof. Autonomous vehicles, such as the AV 102, may, in the course of determining a navigation route, receive instructions from the online system 106 regarding which roads or portions thereof, if any, are appropriate for use under certain circumstances, as described herein. Such instructions may be based in part on information received from the AV 102 or other autonomous vehicles regarding road conditions. Accordingly, the online system 106 may receive information regarding the roads/routes generally in real-time from one or more vehicles.

The online system 106 communicates with the client device 108. For instance, the online system 106 receives delivery requests from the client device 108. A delivery request is a request to deliver one or more items from a location to another location. The delivery request may include information of the items, information of the locations (e.g., store location, distribution center location, warehouse location, location of a customer, etc.), and so on. The online system 106 can provide information associated with the delivery request (e.g., information of the status of the delivery process) to the client device 108.

The client device 108 may be a device (e.g., a computer system) of a user of the online system 106. The user may be an entity or an individual. In some embodiments, a user may be a customer of another user. In an embodiment, the client device 108 is an online system maintained by a business, e.g., a retail business, a package service business, etc. The client device 108 may be an application provider communicating information describing applications for execution by the third-party device 110 or communicating data to the third-party device 110 for use by an application executing on the third-party device 110.

The third-party device 110 is one or more computing devices capable of receiving user input as well as transmitting and/or receiving data via the network. The third-party device 110 may be a device of an individual. The third-party device 110 communicates with the client device 108 to request delivery or return of items. For instance, the third-party device 110 may send a delivery request to the client device 108 through an application executed on the third-party device 110. The third-party device 110 may receive from the client device 108 information associated with the request, such as status of the delivery process. In one embodiment, the third-party device 110 is a conventional computer system, such as a desktop or a laptop computer. Alternatively, the third-party device 110 may be a device having computer functionality, such as a personal digital assistant (PDA), a mobile telephone, a smartphone, or another suitable device. The third-party device 110 is configured to communicate via the network. In one embodiment, the third-party device 110 executes an application allowing a user of the third-party device 110 to interact with the online system 106. For example, the third-party device 110 executes a browser application to enable interaction between the third-party device 110 and the online system 106 via the network. In another embodiment, the third-party device 110 interacts with the online system 106 through an application programming interface (API) running on a native operating system of the third-party device 110, such as IOS® or ANDROID™

Example Online System

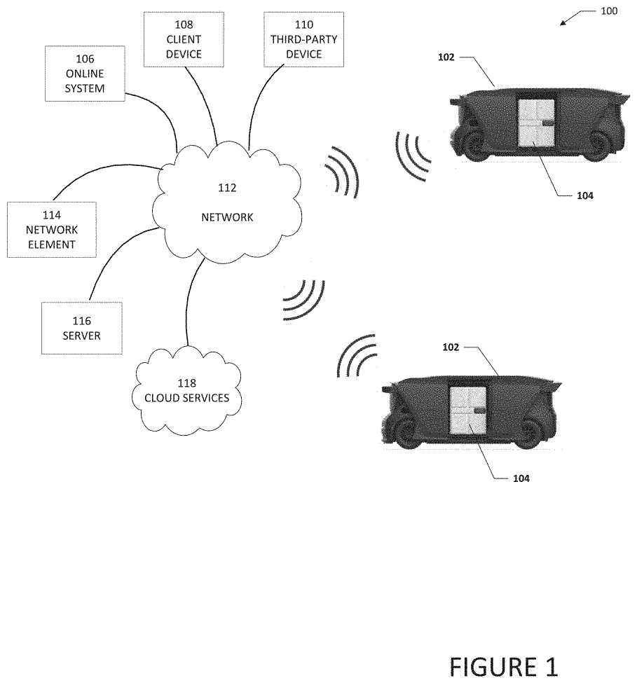

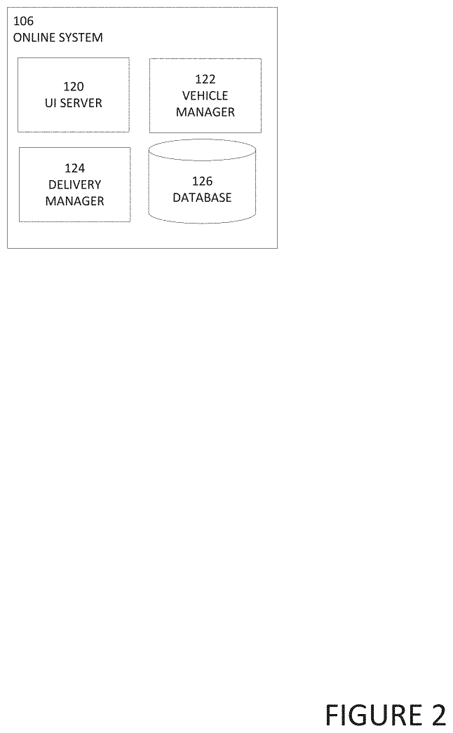

FIG. 2 is a block diagram illustrating the online system 106 according to some embodiments of the present disclosure. The online system 106 can include a UI server 120, a vehicle manager 122, a delivery manager 124, and a database 126. Alternative configurations, different or additional components may be included in the online system 106. Further, functionality attributed to one component of the online system 106 may be accomplished by a different component included in the online system 106 or a different system (e.g., the onboard controller of an AV 102).

The UI server 120 is configured to communicate with third-party devices (e.g., the third-party device 110) that provide a UI to users. For example, the UI server 120 may be a web server that provides a browser-based application to third-party devices, or the UI server 120 may be a mobile app server that interfaces with a mobile app installed on third-party devices. The UI server 120 enables the user to request a delivery by using the AV 102.

The vehicle manager 122 manages and communicates with a fleet of AVs (e.g., the AVs 102). The vehicle manager 122 may assign AVs 102 to various tasks and direct the movements of the AVs 102 in the fleet. For example, the vehicle manager 122 assigns a specific AV 102 to perform a delivery service requested by a user through the UI server 120. The user may be associated with the client device 108. The vehicle manager 122 may instruct AVs 102 to drive to other locations while not servicing a user (e.g., to improve geographic distribution of the fleet, to anticipate demand at particular locations, to drive to a charging station for charging, etc.). The vehicle manager 122 also instructs AVs 102 to return to AV facilities for recharging, maintenance, or storage.

The delivery manager 124 manages delivery services requested by users of the online system 106 (e.g., a user associated with the client device 108). The delivery manager 124 processes a delivery request from a user and sends information in the delivery request to the vehicle manager 122 for the vehicle manager 122 to select a specific AV 102 meeting the need of the user. The delivery manager 124 may also monitor the process of a delivery service (e.g., based on the state of the AV 102 and the state of the delivery assembly 104 in the AV 102). In some embodiments, the delivery manager 124 sends information of the delivery process to the client device 108 so that the user can be informed of the status of the delivery service. The delivery manager 124 may also analyze errors detected during the performance of the delivery service. The delivery manager 124 may assist to resolve the error. For example, the delivery manager 124 may determine a solution to fix the error. The solution may include an instruction to the onboard controller of the AV 102 or to a person loading/unloading the item. As yet another example, the delivery manager 124 communicates the error to the client device 108 and requests the client device 108 to fix the error.

The database 126 stores data used, generated, received, or otherwise associated with the online system 106. For instance, the database 126 stores data associated with the AVs 102, data received from the client device 108, data associated with users of the online system 106, and so on.

Example Onboard Controller

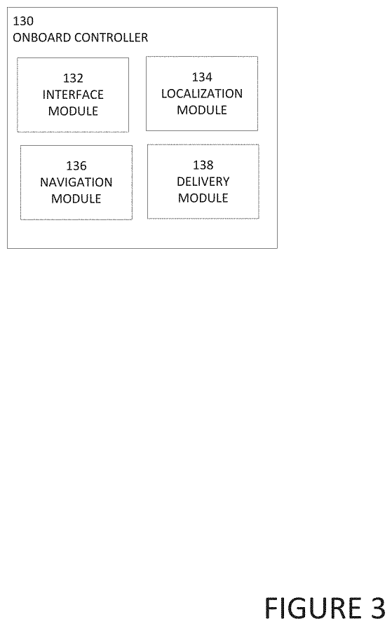

FIG. 3 is a block diagram illustrating an onboard controller 130 of an AV 102 according to some embodiments of the present disclosure. The onboard controller 130 includes an interface module 132, a localization module 134, a navigation module 136, and an AV delivery module 138. Alternative configurations, different or additional components may be included in the onboard controller 130. Further, functionality attributed to one component of the onboard controller 130 may be accomplished by a different component included in the AV 102 or a different system (e.g., the online system 106).

The interface module 132 facilitates communications of the onboard controller 130 with other systems. For instance, the interface module 132 supports communications of the onboard controller 130 with other systems (e.g., the online system 106). The interface module 132 supports communications of the onboard controller 130 with other components of the AV 102 (e.g., the onboard sensor suite, delivery assembly 104, or actuators in the AV 102). For instance, the interface module 132 may retrieve sensor data generated by the onboard sensor suite, communicate with an UI module of the delivery assembly 104, or send commands to the actuators.

The localization module 134 localizes the AV 102. The localization module 134 may use sensor data generated by the onboard sensor suite to determine a location of the AV 102. The sensor data includes information describing an absolute or relative position of the AV 102 (e.g., data generated by GPS, GNSS, IMU, etc.), information describing features surrounding the AV 102 (e.g., data generated by a camera, RADRA, SONAR, LINAR, etc.), information describing motion of the AV 102 (e.g., data generated by the motion sensor), or some combination thereof. In some embodiments, the localization module 134 uses the sensor data to determine whether the AV 102 has entered a local area, such as a parking garage or parking lot where the AV 102 can be charged. In some other embodiments, the localization module 134 may send the sensor data to the online system 106 and receives from the online system 106 a determination whether the AV 102 has entered the local area.

In some embodiments, the localization module 134 determines whether the AV 102 is at a predetermined location (e.g., a destination of a delivery service). For instance, the localization module 134 uses sensor data generated by the onboard sensor suite (or a sensor in the onboard sensor suite) to determine the location of the AV 102. The localization module 134 may further compare the location of the AV 102 with the predetermined location to determine whether the AV 102 has arrived. The localization module 134 may provide locations of the AV 102 to the AV delivery module 138.

The localization module 134 can further localize the AV 102 within the local area. For instance, the localization module 134 determines a pose (position or orientation) of the AV 102 in the local area. In some embodiments, the localization module 134 localizes the AV 102 within the local area by using a model of the local area. The model may be a 2D or 3D representation of the surrounding area, such as a map or a 3D virtual scene simulating the surrounding area. In various embodiments, the localization module 134 receives the model of the local area from the online system 106. The localization module 134 may send a request for the model to the online system 106 and in response, receive the model of the local area. In some embodiments, the localization module 134 generates the request based on sensor data indicating a position or motion of the AV 102. For instance, the localization module 134 detects that the AV 102 is in the local area or is navigated to enter the local area based on the sensor data and sends out the request in response to such detection. This process can be dynamic. For example, the localization module 134 may send new request to the online system 106 as the AV 102 changes its position.

The localization module 134 may further localize the AV 102 with respect to an object in the local area. An example of the object is a building in the local area. The localization module 134 may determine a pose of the AV 102 in relative to the building based on features in the local area. For example, the localization module 134 retrieves sensor data from one or more sensors (e.g., camera, LIDAR, etc.) in the onboard sensor suite that detect the features. The localization module 134 uses the sensor data to determine the pose of the AV 102. The features may be lane markers, street curbs, driveways, and so on. A feature may be two-dimensional or three-dimensional.

The navigation module 136 controls motion of the AV 102. The navigation module 136 may control the motor of the AV 102 to start, pause, resume, or stop motion of the AV 102. The navigation module 136 may further control the wheels of the AV 102 to control the direction the AV 102 will move. In various embodiments, the navigation module 136 generates a navigation route for the AV 102 based on a location of the AV 102, a destination, and a map. The navigation module 136 may receive the location of the AV 102 from the localization module 134. The navigation module 136 receives a request to go to a location and generate a route to navigate the AV 102 from its current location, which is determined by the localization module 134, to the location. The navigation module 136 may receive the destination from the AV delivery module 138 or an external source, such as the online system 106, through the interface module 132.

The AV delivery module 138 manages autonomous delivery by the AV 102. Functionality attributed to the AV delivery module 138 may be accomplished by a different component of the autonomous delivery environment 100, such as the delivery assembly 104. In some embodiments, the AV delivery module 138 processes delivery requests received from the online system 106. The AV delivery module 138 may communicate with the localization module 134 and the navigation module 136 to navigate the AV 102 based on the delivery requests (e.g., to navigate the AV 102 to locations specified in the delivery request).

The AV delivery module 138 may monitor or control the delivery assembly 104 in the AV 102. The AV delivery module 138 may determine a size limit of the delivery assembly 104 (e.g., based on the size of the container in the delivery assembly 104). The AV delivery module 138 may further determine whether the item that the online system 106 requests the AV 102 to deliver (“requested item”) can fit in the delivery assembly 104 based on the size limit. In embodiments that the AV delivery module 138 determines that the requested item has a size larger than the size limit of the delivery assembly 104, the AV delivery module 138 may communicate with the online system 106 to cancel or change the delivery request.

Example Delivery Assembly

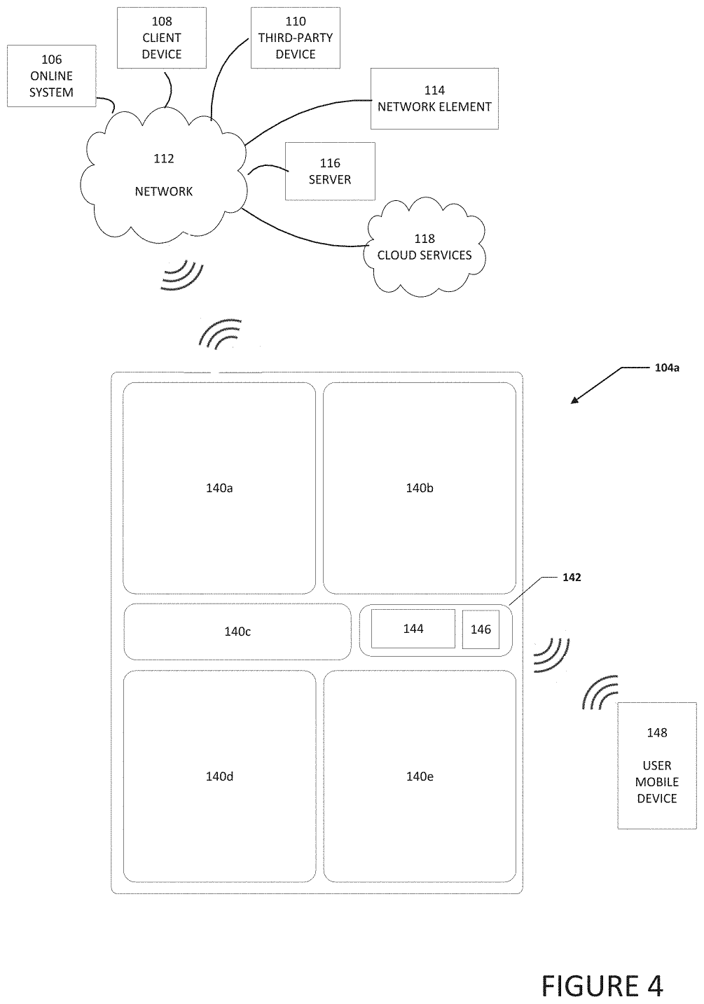

FIG. 4 illustrates a delivery assembly 104 according to some embodiments of the present disclosure. The delivery assembly 104 includes a plurality of cubbies 140a-104e and a UI module 142. In some embodiments, the delivery assembly 104 may include additional and/or different components. For instance, the delivery assembly 104 may include a securing mechanism to secure the delivery assembly 104 to an AV 102. The delivery assembly 104 can communicate with the network 112 (and the online system 106, the third-party device 110, the one or more network elements 114, the one or more servers 116, and cloud services 118) on a separate network path other than the network path used by AV 102. The delivery assembly 104 can also communicate with a user mobile device 148 to authenticate the user and to allow the user to interact with the UI module 142. The user mobile device 148 can be a smart phone, wearable, or some other portable communication device associated with the user.

Each of the cubbies 140a-104e provides space and securement of items delivered by the AV 102 and each of the cubbies 140a-104e may have various shapes or sizes. Each cubby is locked to protect user privacy in embodiments where the AV 102 is used to deliver items to multiple users. For instance, an item for a first user can be placed in the first cubby 140a, and a second item for a second user can be placed in the second cubby 140b. When the first user unloads the first item from the first cubby 140a, the second item is invisible to the first user as the second item is in the second cubby 140b. After the first user finishes unloading the first item (e.g., after the AV 102 closes the door and leaves the location of the first user) or when the second item can be picked up by the second user (e.g., after the AV 102 arrives at the location of the second user), the second cubby 140b can be unlocked and the second item can be collected by the second user.

Each of the cubbies 140a-104e in FIG. 4 are for illustration purposes and in other embodiments, the cubbies 140a-104e may have other configurations. For example, the cubby 140a may be a smaller cubby or cubies 104a and 104b may be combined into one large cubby. Each of the cubbies 140a-104e may also include a shelf, a drawer, a cabinet, or other types of storage components. The delivery assembly 104 may be made of a plastic material, metal, other types of materials, or some combination thereof. In some embodiments, the delivery assembly 104 and each of the cubbies 104a-104c has a size limit and the size of items delivered using the delivery assembly 104 does not exceed the size limit. The delivery assembly 104 may have a frame that can be secured to the AV 102.

The UI module 142 can include a display 144 and a UI input 146. In some examples, the UI input 146 may be a keypad (e.g., a physical keypad or a digital keypad). The UI module 142 provides a user interface to provide users information associated with loading or unloading items. For instance, the display 144 can provide graphical information to the user related to loading or unloading items and the UI input can allow the user to input information related to loading or unloading items. The UI module 142 have a shape that is similar to a rectangular profile and can be located in a middle right-side portion of the delivery assembly 104. In other embodiments, the UI module 142 may have a different shape and/or location.

The UI module 142 informs the user of the state of the item in the delivery assembly 104 or more specifically, a specific cubby (e.g., the item is ready for being picked up, the item has been picked up, etc.), the state of the AV 102 (e.g., a door is open, a door is to be closed, etc.), actions to be taken by the user (e.g., moving a sliding bin, unloading an item, loading an item, closing a door of the AV 102, etc.), and so on. The UI module 142 can also be used to authenticate a user (e.g., the user inters a code using the UI input 146, the user scans a code on their phone into the UI input 146, etc.). For instance, the UI module 430 may include a camera or scanner to capture identification information from the user. The UI module 142 may provide information to users through indicators generated by the UI module 142. An indicator may be light, text, sound, or some combination thereof.

Example Delivery Assembly

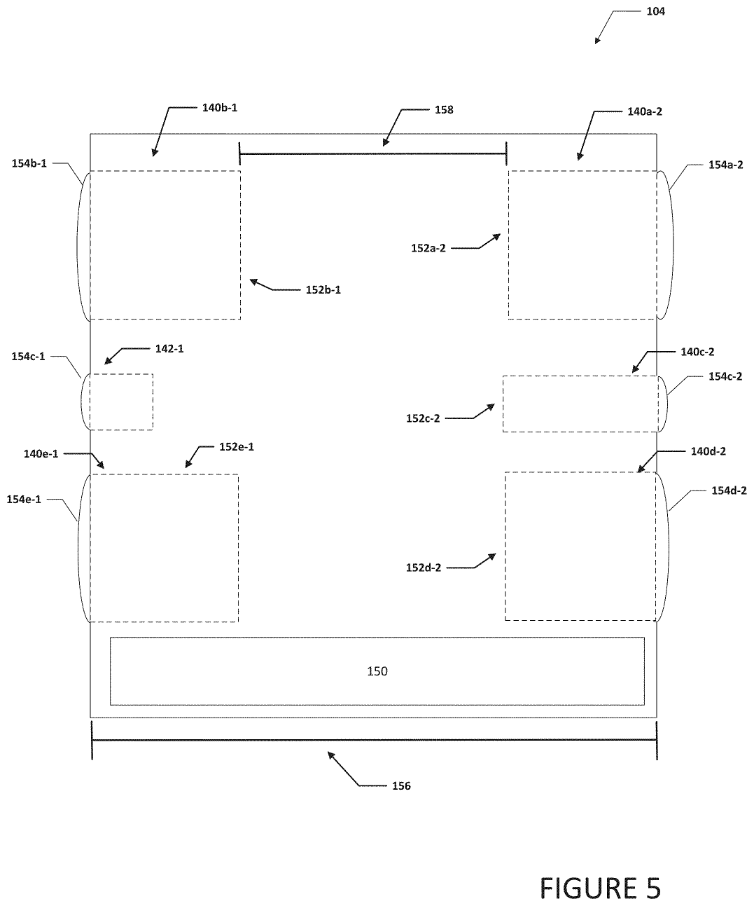

FIG. 5 illustrates the delivery assembly 104 according to some embodiments of the present disclosure. The delivery assembly 104 can include a first side of cubbies, a second side of cubbies, and a battery 150. The first side of cubbies can be a mirror image of the second side of cubbies or one or more of the first side of cubbies may be different than one or more of the second side of cubbies. In an example where the AV parks on a street after it arrives at a destination, the AV opens a curbside door (i.e., the door facing the curb of the street), as opposed to a traffic-side door (i.e., the door facing the traffic on the street) to protect the safety of the user. When the delivery assembly 104 is being used to deliver items to a user, the AV that includes the delivery assembly 104 can pull up and park such that the one or more cubbies that include the user's items is relative to the curbside door of the AV to provide the user access from a safe spot and the user does not have to walk to the traffic-side door to obtain the access to the delivery assembly.

More specifically, FIG. 5 illustrates a side view of the delivery assembly 104 according to some embodiments of the present disclosure. The delivery assembly 104 can include first side cubbies 140a-1-140e-1, first side UI module 142-1, second side cubbies 140a-2-140e-2, and second side UI module 142-2. Because FIG. 5 is a side view, only first side cubbies 140b-1 and 140e-1, UI module 142-1, and second side cubbies 140a-2, 140c-2, and 140d-2 are shown. The first side cubby 140b-1 can include an interior space 152b-1 and a door 154b-1. The first side cubby 140e-1 can include an interior space 152e-1 and a door 154e-1. The second side cubby 140a-2 can include an interior space 152a-2 and a door 154a-2. The second side cubby 140c-2 can include an interior space 152c-2 and a door 154c-2. The second side cubby 140d-2 can include an interior space 152d-2 and a door 154d-2.

The delivery assembly 104 can have a width 156 that depends on the interior width of the AV that includes the delivery assembly 104. In an example, the width 156 of the delivery assembly 104 is less than the interior width of the AV that includes the delivery assembly 104, such that when the doors of the AV are closed, the delivery assembly 104 is completely contained within the AV. The delivery assembly 104 can also have an interior space or channel to allow air to flow through the delivery assembly 104. For example, as illustrated in FIG. 5, an interior space 158 between the first side cubbies 140a-1-140e-1 and the second side cubbies 140a-2-140e-2 can help define the interior space or channel to allow for airflow in the delivery assembly 104.

In some examples, the delivery assembly 104 can be powered by the AV that includes the delivery assembly 104. In other examples, the delivery assembly 104 is self-contained and can be powered by the battery 150. In yet other examples, the delivery assembly 104 can be powered by the AV that includes the delivery assembly 104 unless there is an issue with the power supply from the AV and then the delivery assembly 104 can be powered by the battery 150. The battery 150 can be a rechargeable battery and may be recharged by the AV or can be recharged when the delivery assembly 104 is not in use.

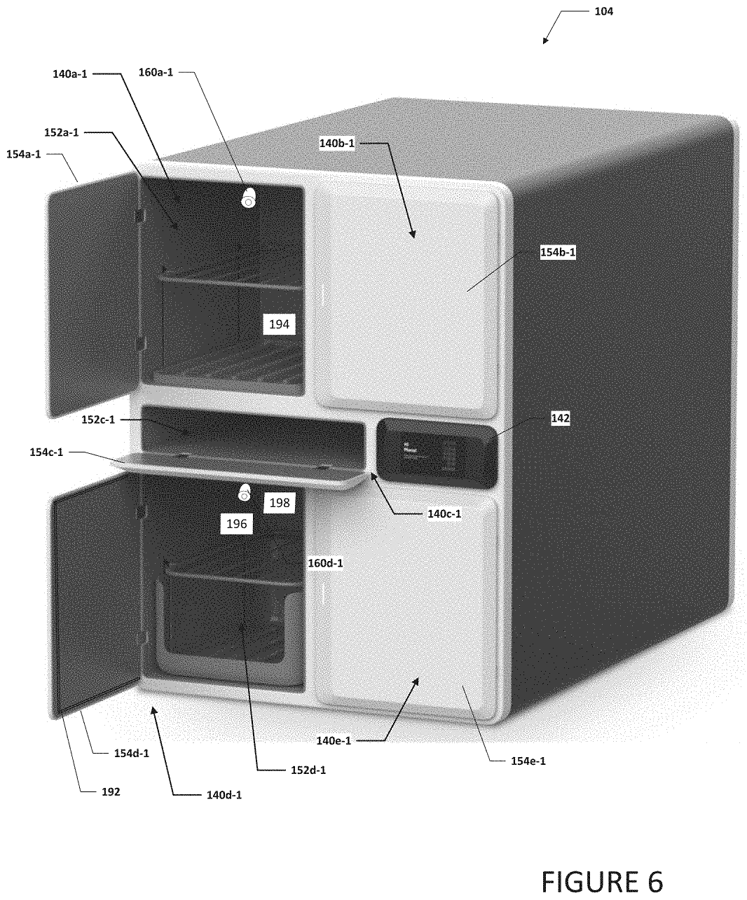

FIG. 6 illustrates the delivery assembly 104 according to some embodiments of the present disclosure. The delivery assembly 104 can include the first side cubbies 140a-1-140e-1 and the first side UI module 142-1 (note the second side cubbies 140a-2-140e-2 and the second side UI module 142-2 are not shown in FIG. 6). One or more of the first side cubbies 140a-1-140e-1 (and the second side cubbies 140a-2-140e-2 (not shown)) can include a camera 160, a temperature sensor 194, a humidity sensor 196, a cubby light 198, and other sensors (e.g., vibration sensor, pressure sensor, etc.) that can be used to determine environmental conditions inside each of the first side cubbies 140a-1-140e-1 and the second side cubbies 140a-2-140e-2. For example, as illustrated in FIG. 6, the first side cubby 140a-1 includes camera 160a-1 and temperature sensor 194, and the first side cubby 140d-1 includes camera 160d-1, the humidity sensor 196, and the cubby light 198. Each camera 160a-1 and 160d-1 can capture a video image or picture of the contents of the first side cubby 140a-1 and of the first side cubby 140d-1 respective. If the camera 160 is present in other cubbies, the camera can capture a video image or picture of the contents of the other cubbies that include the camera 160. In an example, each of the first side cubbies 140a-1-140e-1 (and the second side cubbies 140a-2-140e-2 (not shown)) can include a sensor or mechanism to help determine when a door to a cubby is open or closed. For example, the sensor or mechanism can be an ambient light sensor, a pressure sensor that is activated when the door is closed, etc.

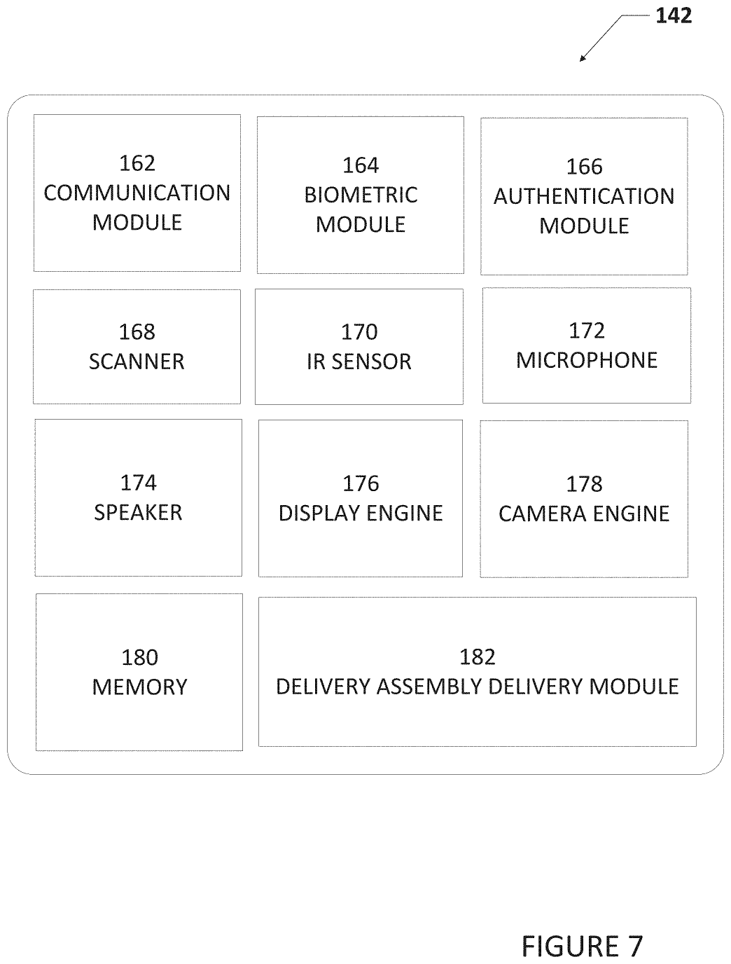

In some examples, each of the first side cubbies 140a-1-140e-1 (and the second side cubbies 140a-2-140e-2 (not shown)) can include one or more visual indicators 192 that can help the user identify a specific cubby door the user can access. Visual indicators 192 can have different shapes and sizes. Visual indicators 192 can coordinate with and/or be controlled by a UI module (e.g., UI module 142 of FIG. 7).

Preferably, the visual indicators 192 are provided with usability and intuitiveness in mind. For instance, the visual indicators 192 can be located on an edge of the door of a cubby that indicates a suitable edge of the door for the user to grab or hold in order to open or close the door.

In another instance, the visual indicators 192 conveys an identifier, such as a number, a letter, or a symbol.

In another instance, the visual indicators 192 conveys which cubby corresponds to the cubby having the user's delivery item or which cubby requires an operator to place the delivery item.

The one or more visual indicators 192 may be light emitting diode (LED) lights that can change colors based on the status of the door (e.g., green for open and ready for access, red for closing, etc.).

In some cases, the visual indicators 192 may flash or blink to alert the user.

In some cases, the visual indicators may display a pattern or a light sequence to alert the user.

In some examples, one or more light pipes can extend through the door to help light from the one or more visual indicators 192 reach the user. In some examples, at least a portion of the door that includes the one or more visual indicators 192 can include a translucent material to help light from the one or more visual indicators 192 reach the user.

In some examples, at least a portion of the door include a portion that is made from a translucent material such that when a light source (e.g., cubby light 198 or another suitable light source inside the cubby) inside the cubby is on, the illumination of the light source can be seen by the user through the portion (even when the door is closed). The portion of the door can have a shape of a number, letter, or symbol. Providing such a portion made from a translucent material in each cubby door and selectively turning on the light source inside the cubby serves as a visual indicator that does not require adding a light source inside the door.

Example UI Module

FIG. 7 illustrates the UI module 142 according to some embodiments of the present disclosure. The UI module 142 can include a communication module 162, a biometric module 164, an authentication module 166, a scanner 168, an infrared (IR) sensor 170, a microphone 172, a speaker 174, a display engine 176, camera engine 178, memory 180, and a delivery assembly delivery module 182. The communication module 162 can help facilitate communications between the delivery assembly 104 and the network 112 (and the online system 106, the third-party device 110, the one or more network elements 114, the one or more servers 116, and cloud services 118). The communication module 162 can also help facilitate communications between the delivery assembly 104 and the AV 102 and between the delivery assembly 104 and a user's mobile device (e.g., the user mobile device 148).

The biometric module 164 can be a biometric sensor or some other device that can collect biometric data of the user. The authentication module 166 can be configured to authentic a user. For example, the authentication module 166 can received biometric data from the biometric module and use the received biometric data to authenticate a user. The scanner 168 may be a bar code scanner, QR code scanner, or some other type of scanner that can be used to help input data into the UI module 142. For example, the scanner 168 may be a QR code scanner that a user can use to help authenticate a user. Also, the scanner 168 can be a bar code scanner where items are scanned into the UI module 142 as they are placed in a cubby.

The IR sensor 170 can be an active IR sensor or a passive IR sensor. The IR sensor can be used to sense characteristics in the environment around the UI module 142 by emitting and/or detecting infrared radiation. More specifically, the IR sensor 170 can detect the heat being emitted by an object and detecting motion of a user (e.g., when a user approaches the delivery assembly 104). The microphone 172 can be used to detect sound, especially voice commands from the user. The speaker 174 can be used to provide audio for the user, especially audio prompts about the location of an item in a specific cubby. The display engine 176 can help provide the visual data that is displayed on the display of the UI module 142. Memory 180 can include data related to the operation of the delivery assembly 104 such as the specific cubby that includes one or more items for a specific user, user authentication data, etc.

The delivery assembly delivery module 182 can use sensor data generated by sensors in the delivery assembly to determine the state of an item in the delivery assembly. For instance, the delivery assembly delivery module 182 detects whether the item has been removed from a cubby or placed into the cubby by using sensor data generated by one or more sensors (e.g., camera, etc.) associated with the cubby. In some embodiments, the delivery assembly delivery module 182 uses the sensor data to determine whether the item matches a description in the delivery request to ensure that the item being remove or placed is the right item. The delivery assembly delivery module 182 may also determine a physical condition of the item.

The delivery assembly delivery module 182 may also manage the UI module 142. For instance, the delivery assembly delivery module 182 generates indicators based on the state of the item or the delivery process and instructs the UI module 142 to provide the indicators to the user. An indicator may be light, text, sound, or some combination thereof. The indicator may inform the user of the state of the item or the delivery process or provide an instruction to the user. In an embodiment, the delivery assembly delivery module 182 generates textual or audio messages and instructs the UI module 142 to display the textual or audio messages. In another embodiment, the delivery assembly delivery module 182 turns on a light on the UI module 142. The delivery assembly delivery module 182 may also control the delivery assembly based on user input received through the UI module 142. For example, the delivery assembly delivery module 182 can cause cubby doors in the delivery assembly to unlock and open as well as to shut and lock based on the user's interaction with the UI module 142.

In some embodiments, the delivery assembly delivery module 182 detects and processes errors occurred during the delivery. For example, the delivery assembly delivery module 182 may detect that the item removed or placed by the user does not match the description of the requested item in the delivery request. After such a detection, the delivery assembly delivery module 182 may send an error message to the UI module 142 to inform the user of the error. The delivery assembly delivery module 182 may also analyze an error, determine a solution to the error, and provide the user an instruction to fix the error through the UI module 142. Additionally, or alternatively, the delivery assembly delivery module 182 may report the error to the online system 106 and request the online system 106 to provide a solution to the error.

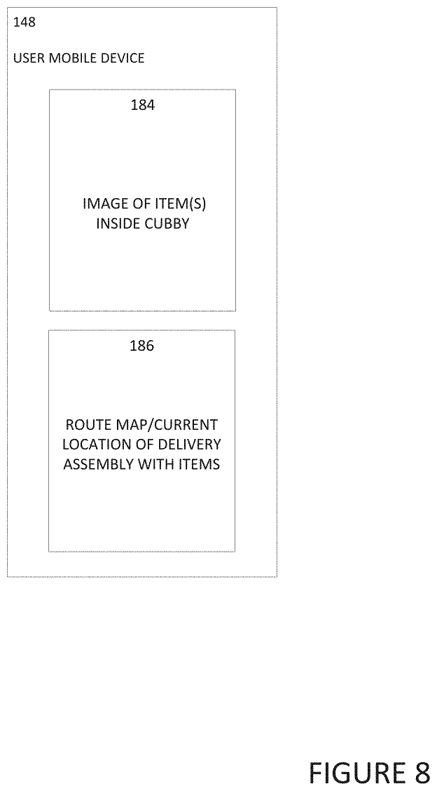

FIG. 8 illustrates an example of one or more images on the user mobile device 148 according to some embodiments of the present disclosure. The UI module 142 (not shown) can communicate with the user mobile device 148 while a retailer or supplier of goods to a customer user is using the delivery assembly 104 and/or while the delivery assembly 104 is on route to the customer user. In an example, the UI module 142 can communicate data related to the one or more items in a cubby and/or the route and current location of the delivery assembly 104 that includes the cubby to the user mobile device 148. More specifically, as illustrated in FIG. 8, the display of the user mobile device 148 can display an item video or picture 184 of the one or more items to be delivered to the user and/or the route map/current location 186 of the delivery assembly 104 that includes the one or items to be delivered to the user. The item video or picture 184 of the one or more items to be delivered to the user can be captured by the camera 160 located in the cubby 140 that includes the one or items to be delivered to the user.

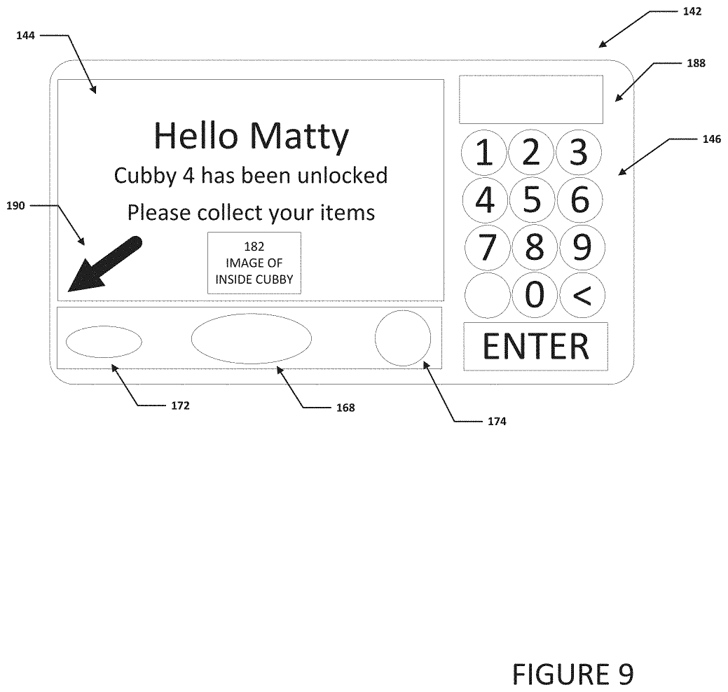

FIG. 9 illustrates the UI module 142 according to some embodiments of the present disclosure. The UI module 142 can include the display 144, the UI input 146, the scanner 168, the microphone 172, and the speaker 174. In some examples, the UI input 146 is a physical keypad. In other examples, the UI input 146 is a virtual keypad. The UI input 146 can include a keypad display 188 to allow the user to see input from the UI input 146.

In some examples, the display 144 can be a touchscreen display. Depending on the use case of the delivery assembly 104 and the UI module 142, the display 144 can present different visual information to the user. More specifically, if a customer user is using the delivery assembly 104, the UI module 142 can be in a customer user mode to allow the customer user to retrieve or collect one or more items from a cubby 140 of the delivery assembly 104 that has been delivered to the customer user by the AV 102. For example, as illustrated in FIG. 9, the display 144 can display specific information related to a customer user. In some examples, an indicator 190 can be used to help the user identify a specific cubby that has been unlocked and can be accessed. More specifically, as illustrated in FIG. 9, the indicator 190 can be an arrow on the display 144 that points to a specific cubby 140 to help the user identify that the specific cubby 140 has been unlocked and can be accessed. Also, the display 144 can include the item video or picture 184 of the one or more items to be delivered to the user. The item video or picture 184 of the one or more items to be delivered to the user can be captured by the camera 160 located in the cubby 140 that includes the one or items to be delivered to the user.

Other Implementation Notes, Variations, and Applications

It is to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

In one example embodiment, any number of electrical circuits of the figures may be implemented on a board of an associated electronic device. The board can be a general circuit board that can hold various components of the internal electronic system of the electronic device and, further, provide connectors for other peripherals. More specifically, the board can provide the electrical connections by which the other components of the system can communicate electrically. Any suitable processors (inclusive of digital signal processors, microprocessors, supporting chipsets, etc.), computer-readable non-transitory memory elements, etc. can be suitably coupled to the board based on particular configuration needs, processing demands, computer designs, etc. Other components such as external storage, additional sensors, controllers for audio/video display, and peripheral devices may be attached to the board as plug-in cards, via cables, or integrated into the board itself. In various embodiments, the functionalities described herein may be implemented in emulation form as software or firmware running within one or more configurable (e.g., programmable) elements arranged in a structure that supports these functions. The software or firmware providing the emulation may be provided on non-transitory computer-readable storage medium comprising instructions to allow a processor to carry out those functionalities.

Additionally, one or more of the AV 102, the delivery assembly 104, and the UI module 142 may include one or more processors that can execute software, logic, or an algorithm to perform activities as discussed herein. A processor can execute any type of instructions associated with the data to achieve the operations detailed herein. In one example, the processors could transform an element or an article (e.g., data) from one state or thing to another state or thing. In another example, the activities outlined herein may be implemented with fixed logic or programmable logic (e.g., software/computer instructions executed by a processor) and the elements identified herein could be some type of a programmable processor, programmable digital logic (e.g., a field programmable gate array (FPGA), an erasable programmable read-only memory (EPROM), an electrically erasable programmable read-only memory (EEPROM)) or an application specific integrated circuit (ASIC) that includes digital logic, software, code, electronic instructions, or any suitable combination thereof. Any of the potential processing elements, modules, and machines described herein should be construed as being encompassed within the broad term ‘processor.’

Implementations of the embodiments disclosed herein may be formed or carried out on a substrate, such as a non-semiconductor substrate or a semiconductor substrate. In one implementation, the non-semiconductor substrate may be silicon dioxide, an inter-layer dielectric composed of silicon dioxide, silicon nitride, titanium oxide and other transition metal oxides. Although a few examples of materials from which the non-semiconducting substrate may be formed are described here, any material that may serve as a foundation upon which a non-semiconductor device may be built falls within the spirit and scope of the embodiments disclosed herein.

In another implementation, the semiconductor substrate may be a crystalline substrate formed using a bulk silicon or a silicon-on-insulator substructure. In other implementations, the semiconductor substrate may be formed using alternate materials, which may or may not be combined with silicon, that include but are not limited to germanium, indium antimonide, lead telluride, indium arsenide, indium phosphide, gallium arsenide, indium gallium arsenide, gallium antimonide, or other combinations of group III-V or group IV materials. In other examples, the substrate may be a flexible substrate including 2D materials such as graphene and molybdenum disulphide, organic materials such as pentacene, transparent oxides such as indium gallium zinc oxide poly/amorphous (low temperature of dep) III-V semiconductors and germanium/silicon, and other non-silicon flexible substrates. Although a few examples of materials from which the substrate may be formed are described here, any material that may serve as a foundation upon which a semiconductor device may be built falls within the spirit and scope of the embodiments disclosed herein.

Each of the AV 102, the delivery assembly 104, and the UI module 142 may include any suitable hardware, software, components, modules, or objects that facilitate the operations thereof, as well as suitable interfaces for receiving, transmitting, and/or otherwise communicating data or information in a network environment. This may be inclusive of appropriate algorithms and communication protocols that allow for the effective exchange of data or information. Electronic devices 100a and 100b may include virtual elements.

In regards to the internal structure associated with the AV 102, the delivery assembly 104, and the UI module 142, each of the AV 102, the delivery assembly 104, and the UI module 142 can include memory elements for storing information to be used in the operations outlined herein. The AV 102, the delivery assembly 104, and the UI module 142 may keep information in any suitable memory element (e.g., random access memory (RAM), read-only memory (ROM), erasable programmable ROM (EPROM), electrically erasable programmable ROM (EEPROM), ASIC, etc.), software, hardware, firmware, or in any other suitable component, device, element, or object where appropriate and based on particular needs. Any of the memory items discussed herein should be construed as being encompassed within the broad term ‘memory element.’ Moreover, the information being used, tracked, sent, or received in the AV 102, the delivery assembly 104, and the UI module 142 could be provided in any database, register, queue, table, cache, control list, or other storage structure, all of which can be referenced at any suitable timeframe. Any such storage options may also be included within the broad term ‘memory element’ as used herein.

In certain example implementations, the functions outlined herein may be implemented by logic encoded in one or more tangible media (e.g., embedded logic provided in an ASIC, digital signal processor (DSP) instructions, software (potentially inclusive of object code and source code) to be executed by a processor, or other similar machine, etc.), which may be inclusive of non-transitory computer-readable media. In some of these instances, memory elements can store data used for the operations described herein. This includes the memory elements being able to store software, logic, code, or processor instructions that are executed to carry out the activities described herein.

It is also imperative to note that all of the specifications, dimensions, and relationships outlined herein (e.g., the number of processors, logic operations, etc.) have only been offered for purposes of example and teaching only. Such information may be varied considerably without departing from the spirit of the present disclosure, or the scope of the appended claims. The specifications apply only to one non-limiting example and, accordingly, they should be construed as such. In the foregoing description, example embodiments have been described with reference to particular arrangements of components. Various modifications and changes may be made to such embodiments without departing from the scope of the appended claims. The description and drawings are, accordingly, to be regarded in an illustrative rather than in a restrictive sense.

Note that with the numerous examples provided herein, interaction may be described in terms of two, three, four, or more components. However, this has been done for purposes of clarity and example only. It should be appreciated that the system can be consolidated in any suitable manner. Along similar design alternatives, any of the illustrated components, modules, and elements of the figures may be combined in various possible configurations, all of which are clearly within the broad scope of this Specification.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. Note that all optional features of the systems and methods described above may also be implemented with respect to the methods or systems described herein and specifics in the examples may be used anywhere in one or more embodiments.

In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph (f) of 35 U.S.C. Section 112 as it exists on the date of the filing hereof unless the words “means for” or “step for” are specifically used in the particular claims; and (b) does not intend, by any statement in the Specification, to limit this disclosure in any way that is not otherwise reflected in the appended claims.

### Other Notes and Examples

Example M1 is a method including determining one or more items have been placed inside a specific cubby of the delivery assembly, wherein the delivery assembly includes a plurality of cubbies, capturing an image of the one or more items inside the specific cubby, and communicating the captured image to a user.

In Example M2, the subject matter of Example M1 can optionally include where the captured image is a video of the one or more items inside the specific cubby.

In Example M3, the subject matter of Example M1 can optionally include where the captured image is communicated a user's mobile device associated with the user.

In Example M4, the subject matter of Example M1 can optionally include determining a current location of the delivery assembly transported by the autonomous vehicle and communicating the current location of the delivery assembly to the user.

In Example M5, the subject matter of Example M4 can optionally include where the captured image and the current location of the delivery assembly are communicated a user's mobile device associated with the user.

In Example, M6, the subject matter of Example M1 can optionally include determining that the delivery assembly transported by the autonomous vehicle has arrived at a delivery location for delivery of the one or more items to the user, determining that the user has access to the one or more items in the specific cubby, and unlocking and opening a door to the specific cubby to allow the user to access the one or more items.

In Example, M7, the subject matter of Example M6 can optionally include determining that the user has removed the one or more items from the specific cubby and closing and locking the door to the specific cubby

In Example, M8, the subject matter of Example M1 can optionally include where a user interface is configured to determine if the user has access to the one or more items by authenticating the user.

In Example, M9, the subject matter of Example M8 can optionally include where the captured image is displayed on the user interface after the user interface authenticates the user.

In Example, M10, the subject matter of Example M8 can optionally include where a specific cubby for the user to access is illuminated after the user interface authenticates the user.

In Example, M11, the subject matter of any of the Examples M1-M2 can optionally include where the captured image is communicated a user's mobile device associated with the user.

In Example, M12, the subject matter of any of the Examples M1-M3 can optionally include determining a current location of the delivery assembly transported by the autonomous vehicle and communicating the current location of the delivery assembly to the user.

In Example, M13, the subject matter of any of the Examples M1-M4 can optionally include where the captured image and the current location of the delivery assembly are communicated a user's mobile device associated with the user.

In Example, M14, the subject matter of any of the Examples M1-M5 can optionally include determining that the delivery assembly transported by the autonomous vehicle has arrived at a delivery location for delivery of the one or more items to the user, determining that the user has access to the one or more items in the specific cubby, and unlocking and opening a door to the specific cubby to allow the user to access the one or more items.

In Example, M15, the subject matter of any of the Examples M1-M6 can optionally include determining that the user has removed the one or more items from the specific cubby and closing and locking the door to the specific cubby.

In Example, M16, the subject matter of any of the Examples M1-M7 can optionally include where a user interface is configured to determine if the user has access to the one or more items by authenticating the user.

In Example, M17, the subject matter of any of the Examples M1-M8 can optionally include where the captured image is displayed on the user interface after the user interface authenticates the user.

In Example, M18, the subject matter of any of the Examples M1-M9 can optionally include where a specific cubby for the user to access is illuminated after the user interface authenticates the user.

Example MM1 is a method including determining one or more items have been placed inside a specific cubby of a delivery assembly located in an autonomous vehicle, wherein the delivery assembly includes a plurality of cubbies for storing items and a user interface, capturing an image of the one or more items inside the specific cubby, determining a location of the autonomous vehicle, and communicating the captured image of the one or more items inside the specific cubby and the location of the autonomous vehicle to a user.

In Example MM2, the subject matter of Example MM1 can optionally include where the captured image and the location of the autonomous vehicle are communicated a user's mobile device associated with the user.

In Example MM3, the subject matter of Example MM2 can optionally include determining that the delivery assembly transported by the autonomous vehicle has arrived at a delivery location for delivery of the one or more items to the user, determining that the user has access to the one or more items in the specific cubby, and unlocking and opening a door to the specific cubby to allow the user to access the one or more items.

In Example MM4, the subject matter of Example MM13 can optionally include where a specific cubby for the user to access is illuminated after the user interface authenticates the user.

In Example MM5, the subject matter of any of the Examples MM1-MM2 can optionally include determining that the delivery assembly transported by the autonomous vehicle has arrived at a delivery location for delivery of the one or more items to the user, determining that the user has access to the one or more items in the specific cubby, and unlocking and opening a door to the specific cubby to allow the user to access the one or more items.

In Example MM6, the subject matter of any of the Examples MM1-MM3 can optionally include where a specific cubby for the user to access is illuminated after the user interface authenticates the user.

In Example MM7, the subject matter of any of the Examples MM1-MM4 can optionally include determining that the delivery assembly transported by the autonomous vehicle has arrived at a delivery location for delivery of the one or more items to the user, determining that the user has access to the one or more items in the specific cubby, and unlocking and opening a door to the specific cubby to allow the user to access the one or more items.

In Example, MM8, the subject matter of any of the Examples MM1-MM5 can optionally include where the captured image is a video of the one or more items inside the specific cubby.

In Example, MM9, the subject matter of any of the Examples MM1-MM6 can optionally include determining that the user has removed the one or more items from the specific cubby and closing and locking the door to the specific cubby.

In Example, MM10, the subject matter of any of the Examples MM1-MM7 can optionally include where a user interface is configured to determine if the user has access to the one or more items by authenticating the user.

In Example, MM11, the subject matter of any of the Examples MM1-MM8 can optionally include where the captured image is displayed on the user interface after the user interface authenticates the user.

Example A1, is an autonomous delivery system to deliver items to a customer user using an autonomous vehicle, the autonomous delivery system comprising a delivery assembly, wherein the delivery assembly can be removably secured in the autonomous vehicle, a plurality of cubbies located in the delivery assembly, wherein each of the plurality of cubbies can store one or more items to be delivered to the customer user, and a camera inside at least one of the plurality of cubbies, wherein the camera can capture an image of the one or more items to be delivered to the customer user.

In Example A2, the subject matter of Example A1 can optionally include where the captured image and a current location of the autonomous delivery system is communicated a user's mobile device associated with the customer user.

In Example A3, the subject matter of Example A1 can optionally include a visual indicator that becomes activated to inform a user of a specific cubby to access.

In Example A4, the subject matter of Example A3 can optionally include where the visual indicator is an LED light.

In Example A5, the subject matter of Example A4 can optionally include where the LED light is located inside the specific cubby and a light pipe is used to direct light from the LED light to the user.

In Example A6, the subject matter of any of Example A4 can optionally include where the visual indicator is located inside the specific cubby and a door of the specific cubby is translucent to allow light from the LED light to be directed towards the user.

In Example A7, the subject matter of any of Examples A1-A2 can optionally include a visual indicator that becomes activated to inform a user of a specific cubby to access.

In Example A8, the subject matter of any of Examples A1-A3 can optionally include where the visual indicator is an LED light.

In Example A9, the subject matter of any of Examples A1-A4 can optionally include where the LED light is located inside the specific cubby and a light pipe is used to direct light from the LED light to the user.

In Example A10, the subject matter of any of Examples A1-A5 can optionally include where the visual indicator is located inside the specific cubby and a door of the specific cubby is translucent to allow light from the LED light to be directed towards the user.

In Example A11, the subject matter of any of Examples A1-A6 can optionally include where a slide mechanism to extend a bin towards the user, wherein the bin contains at least a portion of the one or more items to be delivered to the user.

In Example A12, the subject matter of any of Examples A1-A7 can optionally include where the delivery assembly includes a user interface and the user interface includes a keypad and a display, wherein the display includes the image of the one or more items to be delivered to the user.

In Example A13, the subject matter of any of Examples A1-A8 can optionally include where the captured image is a video that is communicated a user's mobile device associated with the user.

In Example A14, the subject matter of any of Examples A1-A9 can optionally include where the delivery assembly includes a user interface and the user interface is used to authenticate the user and cause a door of a specific cubby to open.

In Example A15, the subject matter of any of Examples A1-A10 can optionally include a visual indicator that becomes activated to inform a user of a specific cubby to access.

Example AA1 is a device including at least one machine-readable medium comprising one or more instructions that, when executed by at least one processor, causes the at least one processor to determine one or more items have been placed inside a specific cubby of the delivery assembly, wherein the delivery assembly includes a plurality of cubbies, capture an image of the one or more items inside the specific cubby, and communicate the captured image to a user.

In Example AA2, the subject matter of Example AA1 can optionally where the captured image is a video of the one or more items inside the specific cubby.

In Example AA3, the subject matter of Example AA2 can optionally include where the captured image is communicated a user's mobile device associated with the user.

In Example AA4, the subject matter of Example AA1 can optionally include one or more instructions that, when executed by at least one processor, causes the at least one processor to, determine a current location of the delivery assembly transported by the autonomous vehicle and communicate the current location of the delivery assembly to the user.

In Example AA5, the subject matter of Example AA1 can optionally include where the captured image and the current location of the delivery assembly are communicated a user's mobile device associated with the user.

In Example AA6, the subject matter of Example AA1 can optionally include one or more instructions that, when executed by at least one processor, causes the at least one processor to determine that the delivery assembly transported by the autonomous vehicle has arrived at a delivery location for delivery of the one or more items to the user, determine that the user has access to the one or more items in the specific cubby, and unlock and open a door to the specific cubby to allow the user to access the one or more items.

In Example AA7, the subject matter of any of Examples AA1-AA2 can optionally include one or more instructions that, when executed by at least one processor, causes the at least one processor to, determine that the user has removed the one or more items from the specific cubby and clos and locking the door to the specific cubby.

In Example, AA8, the subject matter of Example AA1 can optionally include where a user interface is configured to determine if the user has access to the one or more items by authenticating the user.

In Example, AA9, the subject matter of Example AA8 can optionally include where the captured image is displayed on the user interface after the user interface authenticates the user.

In Example, AA10, the subject matter of Example AA8 can optionally include where a specific cubby for the user to access is illuminated after the user interface authenticates the user.

In Example, AA11, the subject matter of any of the Examples AA1-AA2 can optionally include where the captured image is communicated a user's mobile device associated with the user.

In Example, AA12, the subject matter of any of the Examples AA1-AA3 can optionally include one or more instructions that, when executed by at least one processor, causes the at least one processor to, determine a current location of the delivery assembly transported by the autonomous vehicle and communicate the current location of the delivery assembly to the user.

In Example, AA13, the subject matter of any of the Examples AA1-AA4 can optionally include where the captured image and the current location of the delivery assembly are communicated a user's mobile device associated with the user.

In Example, AA14, the subject matter of any of the Examples AA1-AA5 can optionally include one or more instructions that, when executed by at least one processor, causes the at least one processor to, determine that the delivery assembly transported by the autonomous vehicle has arrived at a delivery location for delivery of the one or more items to the user, determine that the user has access to the one or more items in the specific cubby, and unlock and open a door to the specific cubby to allow the user to access the one or more items.

In Example, AA15, the subject matter of any of the Examples AA1-AA6 can optionally include determining that the user has removed the one or more items from the specific cubby and closing and locking the door to the specific cubby.

In Example, AA16, the subject matter of any of the Examples AA1-AA7 can optionally include where a user interface is configured to determine if the user has access to the one or more items by authenticating the user.

In Example, AA17, the subject matter of any of the Examples AA1-AA8 can optionally include where the captured image is displayed on the user interface after the user interface authenticates the user.

In Example, AA18, the subject matter of any of the Examples AA1-AA9 can optionally include where a specific cubby for the user to access is illuminated after the user interface authenticates the user.

Example S1 is a method including means for determining one or more items have been placed inside a specific cubby of a delivery assembly located in an autonomous vehicle, wherein the delivery assembly includes a plurality of cubbies for storing items and a user interface, means for capturing an image of the one or more items inside the specific cubby, means for determining a location of the autonomous vehicle, and means for communicating the captured image of the one or more items inside the specific cubby and the location of the autonomous vehicle to a user.

In Example S2, the subject matter of Example S1 can optionally include where the captured image and the location of the autonomous vehicle are communicated a user's mobile device associated with the user.

In Example S3, the subject matter of Example S2 can optionally include means for determining that the delivery assembly transported by the autonomous vehicle has arrived at a delivery location for delivery of the one or more items to the user, means for determining that the user has access to the one or more items in the specific cubby, and means for unlocking and opening a door to the specific cubby to allow the user to access the one or more items.

In Example S4, the subject matter of Example S13 can optionally include where a specific cubby for the user to access is illuminated after the user interface authenticates the user.

In Example S5, the subject matter of any of the Examples S1-52 can optionally include means for determining that the delivery assembly transported by the autonomous vehicle has arrived at a delivery location for delivery of the one or more items to the user, means for determining that the user has access to the one or more items in the specific cubby, and means for unlocking and opening a door to the specific cubby to allow the user to access the one or more items.

In Example S6, the subject matter of any of the Examples S1-53 can optionally include where a specific cubby for the user to access is illuminated after the user interface authenticates the user.

In Example S7, the subject matter of any of the Examples S1-54 can optionally include means for determining that the delivery assembly transported by the autonomous vehicle has arrived at a delivery location for delivery of the one or more items to the user, means for determining that the user has access to the one or more items in the specific cubby, and means for unlocking and opening a door to the specific cubby to allow the user to access the one or more items.

In Example, S8, the subject matter of any of the Examples S1-S5 can optionally include where the captured image is a video of the one or more items inside the specific cubby.

In Example, S9, the subject matter of any of the Examples S1-S6 can optionally include means for determining that the user has removed the one or more items from the specific cubby and closing and locking the door to the specific cubby.

In Example, S10, the subject matter of any of the Examples S1-S7 can optionally include where a user interface is configured to determine if the user has access to the one or more items by authenticating the user.

In Example, S11, the subject matter of any of the Examples S1-S8 can optionally include where the captured image is displayed on the user interface after the user interface authenticates the user.

Example X1 is a machine-readable storage medium including machine-readable instructions to implement a method or realize an apparatus as in any one of the Examples A1-A15, M1-M18, MM1-MM11, or S1-S11. Example Y1 is an apparatus comprising means for performing any of the Example methods M1-M18 or MM1-MM11. In Example Y2, the subject matter of Example Y1 can optionally include the means for performing the method comprising a processor and a memory. In Example Y3, the subject matter of Example Y2 can optionally include the memory comprising machine-readable instructions.

What is claimed is:

1. A method for facilitating autonomous delivery using a delivery assembly transported by an autonomous vehicle, the method comprising:
determining one or more items have been placed inside a specific cubby of the delivery assembly, wherein the delivery assembly includes a plurality of cubbies;
capturing an image of the one or more items inside the specific cubby; and
communicating the captured image to a user.

2. The method of claim 1, wherein the captured image is a video of the one or more items inside the specific cubby.

3. The method of claim 1, wherein the captured image is communicated a user's mobile device associated with the user.

4. The method of claim 1, further comprising:
determining a current location of the delivery assembly transported by the autonomous vehicle; and
communicating the current location of the delivery assembly to the user.

5. The method of claim 4, wherein the captured image and the current location of the delivery assembly are communicated a user's mobile device associated with the user.

6. The method of claim 1, further comprising:
determining that the delivery assembly transported by the autonomous vehicle has arrived at a delivery location for delivery of the one or more items to the user;
determining that the user has access to the one or more items in the specific cubby; and
unlocking and opening a door to the specific cubby to allow the user to access the one or more items.

7. The method of claim 6, further comprising
determining that the user has removed the one or more items from the specific cubby; and
closing and locking the door to the specific cubby.

8. The method of claim 1, wherein a user interface is configured to determine if the user has access to the one or more items by authenticating the user.

9. The method of claim 8, wherein the captured image is displayed on the user interface after the user interface authenticates the user.

10. The method of claim 8, wherein a specific cubby for the user to access is illuminated after the user interface authenticates the user.

11. A method comprising:
determining one or more items have been placed inside a specific cubby of a delivery assembly located in an autonomous vehicle, wherein the delivery assembly includes a plurality of cubbies for storing items and a user interface;
capturing an image of the one or more items inside the specific cubby;
determining a location of the autonomous vehicle; and
communicating the captured image of the one or more items inside the specific cubby and the location of the autonomous vehicle to a user.

12. The method of claim 11, wherein the captured image and the location of the autonomous vehicle are communicated a user's mobile device associated with the user.

13. The method of claim 11, further comprising:
determining that the delivery assembly transported by the autonomous vehicle has arrived at a delivery location for delivery of the one or more items to the user;
determining that the user has access to the one or more items in the specific cubby; and
unlocking and opening a door to the specific cubby to allow the user to access the one or more items.

14. The method of claim 13, wherein a specific cubby for the user to access is illuminated after the user interface authenticates the user.

15. An autonomous delivery system to deliver items to a customer user using an autonomous vehicle, the autonomous delivery system comprising:
a delivery assembly, wherein the delivery assembly can be removably secured in the autonomous vehicle;
a plurality of cubbies located in the delivery assembly, wherein each of the plurality of cubbies can store one or more items to be delivered to the customer user; and
a camera inside at least one of the plurality of cubbies, wherein the camera can capture an image of the one or more items to be delivered to the customer user.

16. The autonomous delivery system of claim 15, wherein the captured image and a current location of the autonomous delivery system is communicated a user's mobile device associated with the customer user.

17. The autonomous delivery system of claim 15, further comprising:
a visual indicator that becomes activated to inform a user of a specific cubby to access.

18. The autonomous delivery system of claim 17, wherein the visual indicator is an LED light.

19. The autonomous delivery system of claim 18, wherein the LED light is located inside the specific cubby and a light pipe is used to direct light from the LED light to the user.

20. The autonomous delivery system of claim 18, wherein the visual indicator is located inside the specific cubby and a door of the specific cubby is translucent to allow light from the LED light to be directed towards the user.
